(19) United States
(12) Patent Application Publication
(10) Pub. No.: US 2004/0017172 A1
(43) Pub. Date: Jan. 29, 2004

(54) Pulse width modulation motor driving device for controlling driving operation of a three-phase motor at the start and ordinary rotational frequency

(75) Inventors: Masaharu Hoashi, Tokyo (JP); Katsumi Miyazaki, Tokyo (JP)

Correspondence Address: BURNS, DOANE, SWECKER & MATHIS, L.L.P., P.O. Box 1404, Alexandria, VA, 22313-1404, US

(73) Assignees: MITSUBISHI DENKI KABUSHIKI KAISHA; MITSUBISHI ELECTRIC ENGINEERING COMPANY LIMITED

(21) Appl. No.: 10/349,974

(22) Filed: Jan. 24, 2003

(30) Foreign Application Priority Data
Jul. 24, 2002 (JP) 2002-215429

(51) Int. Cl. G05B 11/28

(52) U.S. Cl. 318/599

(57) ABSTRACT

A PWM duty ratio control signal having pulses set to a frequency higher than an audio frequency range and set to a fixed duty ratio is produced in a PWM duty ratio control signal producing unit. In a PWM control unit, when a rotational frequency of a motor is lower than a prescribed rotational frequency, a time period ratio of a charging operation to a discharging operation for the motor is determined according to the fixed duty ratio of the PWM duty ratio control signal. The rotational frequency of the motor lower than the prescribed rotational frequency denotes that a driving operation of the motor is just started. A driving unit drives the motor to alternately perform the charging operation and the discharging operation of the motor with the time period ratio.

### BACKGROUND OF THE INVENTION

1. Field of the Invention

The present invention relates to a pulse width modulation (hereinafter, called PWM) motor driving device in which the generation of vibration and noise placed within an audio frequency range is suppressed when a driving load on a motor is considerably increased.

2. Description of Related Art

FIG. 3 is a block diagram showing a schematic configuration of a conventional current chopper type PWM motor driving device. In general, a current chopper type three-phase brushless motor has three load coils connected to each other in Y-shape, and the three load coils correspond to a W-phase, a U-phase and a V-phase respectively. A conventional PWM motor driving device connected to the load coil of the W-phase is shown in FIG. 3. Also, a motor driving device having the same configuration as the conventional PWM motor driving device connected to the load coil of the W-phase is connected to each of the load coils of the U-phase and the V-phase.

In FIG. 3, 110u indicates a U-phase load coil connected to a conventional PWM motor driving device (not shown) of the U-phase through a U-phase terminal U. 110v indicates a V-phase load coil connected to a conventional PWM motor driving device (not shown) of the V-phase through a V-phase terminal V. 110w indicates a W-phase load coil connected to a conventional PWM motor driving device (not shown) of the W-phase through a W-phase terminal W. 100 indicates a three-phase brushless motor driven according to an output current flowing through two of the load coils 110u, 110v and 110w. 101 indicates a motor driving current flowing from the motor driving device of the U-phase to the ground through the load coils 110u and 110w and the motor driving device of the W-phase. 102 indicates a regenerative current flowing from the load coils 110u and 11w to a power source Va through the motor driving device of the W-phase to return charge remaining in the load coils 110u and 110w to the power source Va. 103 indicates a driving unit. 104 indicates a-latch unit. 105 indicates a comparator. 106 indicates a PWM carrier signal producing unit. 107 indicates a switching transistor formed of a p-channel metal-oxide semiconductor field effect transistor (pMOSFET). 108 indicates a switching transistor formed of anon-channel MOSFET. 109 indicates a load resistor placed between the switching transistor 108 and the ground.

Next, an operation of the conventional PWM motor driving device will be described below.

The conventional PWM motor driving device controls the three-phase brushless motor 100 to be adequately driven. In this driving control, a so-called current chopper type PWM control method is used to control an output current flowing through two of the load coils 110u, 110v and 110w in both the start operation and the steady rotor rotating operation of the motor 100.

In detail, a pulse of a PWM carrier signal produced in the PWM wave producing unit 106 is input to the driving unit 103 through the latch unit 104. When a leading edge of the pulse of the PWM carrier signal output from the latch unit 104 is detected in the driving unit 103, the driving unit 103 outputs a control signal of a high level to the switching transistors 107 and 108. Therefore, the switching transistor 107 is set to the off-state, and the switching transistor 108 is set to the on-state. Thereafter, the driving current 101 flows through the load coils 110u and 110w of the motor 100, and the driving current 101 is output to the ground through the switching transistor 108 and the load resistor 109. Therefore, a voltage applied to the load resistor 109 is indicated at the inlet of the load resistor 109. The voltage applied to the load resistor 109 is input to the comparator 105.

In the comparator 105, the voltage applied to the load resistor 109 is compared with a referential voltage REF, and a latch control signal depending on a comparison result is input to the latch unit 104. In cases where the voltage applied to the load resistor 109 is higher than the referential voltage REF, the comparator 105 judges that a value of the driving current 101 is higher than a prescribed limit value. Therefore, in cases where the voltage applied to the load resistor 109 is higher than the referential voltage REF, the comparator 105 controls the latch unit 104 to be reset, and a latch signal set to a low level is input to the driving unit 103. In response to the low level of the latch signal, the driving unit 103 outputs a control signal of a low level to the switching transistors 107 and 108. Therefore, the switching transistor 108 is set to the off-state, and the switching transistor 107 is set to the on-state. In this case, the flow of the driving current 101 is stopped, and a current path from the load coils 110u and 110w of the motor 100 to the power source Va through the switching transistor 107 is obtained for the regenerative current 102. In other words, a current limiting operation is performed, and charge remaining in the load coils 110u and 110w is returned to the power source Va as the regenerative current 102.

Thereafter, when a leading edge of a next pulse of the PWM carrier signal output from the latch unit 104 is detected in the driving unit 103, the driving unit 103 again outputs a control signal of a high level to the switching transistors 107 and 108, the switching transistor 108 is set to the on-state, and the switching transistor 107 is set to the off-state.

The motor 100 is driven while cyclically selecting two of the loads coils 110u, 110v and 110w and repeatedly performing the above-described current limiting operation. Therefore, the comparator 105 and the load resistor 109 function as a current limiting means of the motor 100.

As is described above, in the conventional current chopper type PWM motor driving device, the driving current 101 flowing through the motor 100 is detected, and a feed-back control is performed for the motor 100. Therefore, as compared with a direct PWM method, this conventional PWM motor driving device has a high performance for the linearity of a transfer conductance between input and output of the motor 100. Also, the current limiting means such as the comparator 105 and the load resistor 109 can be obtained in a comparatively simple configuration.

FIG. 4 is an explanatory view showing a discharging operation and a discharging operation (or a regenerative operation) of the conventional current chopper type PWM motor driving device. In FIG. 4, L indicates an inductance of the load coils 110u and 110w of the motor 100 through which the current 101 or 102 flows. R indicates a resistance of the load coils 110u and 110w of the motor 100. Va indicates a voltage supplied from the power source to the load coils 110u and 110w. Therefore, FIG. 4 shows an equivalent circuit of the load coils 110u and 110w, for example, existing in a current line of the current 101 or 102 which flows from the motor driving device of the U-phase to the motor driving device of the W-phase.

FIG. 5 is a timing chart of a PWM carrier signal, an output current (a sum of the charging current 101 and the regenerative current 102) in a steady rotor rotating operation and an output current produced due to a ripple period multiple phenomenon at the start of the driving operation. When the current limiting operation is performed for the motor 100 in the conventional PWM motor driving device, a waveform of the output current and a waveform of the PWM carrier signal shown in FIG. 5 are obtained.

In cases where the load coils 110u and 110w charged by the conventional PWM motor driving device are expressed by the equivalent circuit shown in FIG. 4, the load coils 110u and 110w have the inductance L and the resistance R, an operation of accumulating charge in the load coils 110u and 110w in a charging time period T1 and an operation of returning the charge accumulated in the load coils 110u and 110w to the power source in a regenerative time period T2 are alternately performed according to both the inductance L and the resistance R. Therefore, the current flowing through the load coils 110u and 110w is averaged according to a filter effect of the inductance L of the load coils 110u and 110w.

In the charging time period T1, the driving current 101 flows through the load coils 110u and 110w of the motor 100 and the conventional PWM motor driving device and is output to the ground through the load resistor 109. In the regenerative time period T2, the regenerative current 102 flows through the load coils 110u and 110w of the motor 100 and the conventional PWM motor driving device and is returned to the power source Va. In this case, the time periods T1 and T2 are determined in relation to both the inductance L and the resistance R of the equivalent circuit shown in FIG. 4 according to equations (1) and (2).

T1=L/R×ln(I2/I1) (1)

T2=L/R×ln{(Im−I1)/(Im−I2)} (2)

Here, Im=Va/R is satisfied. Also, as shown in FIG. 5, I1 denotes a value of current normally flowing through the load coils 110u and 110w of the motor 100, and I2 denotes an upper limit value of the output current flowing through the load coils 110u and 110w of the motor 100.

In cases where a steady rotor rotating operation is performed in the motor 100 under the control of the conventional PWM motor driving device, the output current flowing through the load coils 110u and 110w of the motor 100 is maintained to a low value. In this steady operation of the motor 100, the charging time period T1 is shorter than the regenerative time period T2(T1<T2), and the motor 100 is driven while performing an alternate change of the charging operation and the discharging operation in response to each leading edge of the PWM carrier signal. Therefore, as shown in FIG. 5, when a leading edge of the PWM carrier signal is detected in the driving unit 103, the driving current 101 in the steady operation rapidly flows through the load coils 110u and 110w of the motor 100, and the load coils 110u and 110w of the motor 100 are charged. When the value of the driving current 101 is increased from the value I1 and reaches the upper limit value I2 in the charging time period T1, the comparator 105 resets the latch unit 104, and the flow of the driving current 101 is stopped. Therefore, the charging operation for the load coils 110u and 110w of the motor 100 is stopped. Thereafter, the charge accumulated in the load coils 110u and 110w of the motor 100 is discharged, and the value of the driving current 101 is decreased to the value I1 in the regenerative time period T2. Also, when a next pulse of the PWM carrier signal produced in the PWM carrier signal producing unit 106 is detected in the driving unit 103, the discharging operation (or regenerative operation) is changed to the charging operation. The charging operation and the discharging operation are alternately performed, and the motor 100 is driven under the control of the conventional PWM motor driving device.

However, Because the conventional PWM motor driving device shown in FIG. 3 has the above-described configuration, when an electric power consumed in the motor 100 is heightened in a start operation of the motor 100, as shown in FIG. 5, the waveform of the output current is undesirably changed to that in a ripple period multiple phenomenon. In this ripple period multiple phenomenon, a current ripple period of the output current is multiplied, and the current ripple period of the output current is increased to twice or third times of a pulse interval of the PWM carrier signal. In detail, when an electric power required in the motor 100 is heightened, the charging time period T1 is changed to be longer than the regenerative time period T2(T1>T2), and it takes a long time to increase the value of the charging current 101 to the current upper limit value I2 in the charging operation performed just after the detection of a leading edge of the PWM carrier signal. As a result, the charging operation performed in response to the leading edge of the PWM carrier signal is still continued when a next leading edge of the PWM carrier signal is detected in the driving unit 103, the change from the discharging operation to the charging operation is not performed in response to the next leading edge of the PWM carrier signal, and the charging operation is continued until the value of the output current reaches the current limit value I2. Therefore, the start of the discharging operation is delayed. For example, the discharging operation is delayed by one pulse repetition interval of the PWM carrier signal, and the ripple period of the output current is multiplied. Also, as the charging time period T1 is lengthened, the ripple period of the output current is increased to three times or four times of the pulse repetition interval of the PWM carrier signal. Because T1>T2 is satisfied, the ripple period multiple of the output current occurs. Therefore, an occurrence condition of the ripple period multiple is obtained from the equations (1) and (2).

L/R×ln(I2/I1)>L/R×ln{(Im−I1)/(Im−I2)} (3)

Therefore,

∴I2/I1>(Im−I1)/(Im−I2) (4)

Therefore,

∴I1+I2>Im (5)

In this case, even though a frequency of the PWM carrier signal is set to a value sufficiently higher than an audio frequency range to prevent a frequency of the output current from being placed within the audio frequency range, the frequency of the output current is decreased to a current ripple frequency due to the ripple period multiple phenomenon, and the current ripple frequency of the output current undesirably reaches the audio frequency range. As a result, vibration or noise of the audio frequency range is generated in the motor 100 due to the output current of which the value is changed at the current ripple frequency, and noise generated at the start of the driving operation of the motor 100 is increased.

Next, another prior art will be described.

FIG. 6 is a timing chart of both a motor current (or an output current) flowing through a motor controlled by another conventional PWM motor driving device and a motor current control signal of. In FIG. 6, 601 indicates a motor current-carrying time period. The motor current-carrying time period 601 is changeable. 602 indicates a timer operating time period. The timer operating time period 602 is fixed. A timer is operated during the timer operating time period 602. 603 denotes an operation repetition period of the charging and discharging operations of the motor performed under the control of the conventional PWM motor driving device. The operation repetition period 603 is equal to a sum of both the motor current-carrying time period 601 and the timer operating time period 602. The operation repetition period 603 is gradually lengthened and reaches a time period longer than a cycle corresponding to a maximum frequency of the audio frequency range. Therefore, a frequency corresponding to the operation repetition period 603 is equal to or lower than 20 kHz denoting a maximum audio frequency.

When the driving operation of the motor is started, as shown in FIG. 6, the motor current provided for the motor is controlled according to the motor current control signal in the conventional PWM motor driving device. In this control operation, when the motor current exceeds a limit value in a charging operation, the charging operation is compulsorily changed to a discharging operation denoting a regenerative operation, and charge accumulated in load coils of the motor is compulsorily returned to a power source. Also, in simultaneous with the start of-the discharging operation, a count operation is started in a timer, and an elapsed time of the discharging operation is measured in the conventional PWM motor driving device. When a prescribed time period is elapsed, the discharging operation is compulsorily changed to a next charging operation, and this charging operation is performed until the motor current reaches the current limit value.

In the example of the motor current control signal shown in FIG. 6, when the motor current reaches the current limit value during the motor current-carrying time period 601, the discharging operation is performed during the timer operating time period 602 measured by a timer. Thereafter, when the timer operating time period 602 is elapsed, a current-carrying control is performed for the motor to perform the charging operation. The charging operation in the motor current-carrying time period 601 and the discharging operation in the timer operating time period 602 are alternately performed.

However, even though the current-carrying control is performed for the motor according to the motor current control signal by compulsorily changing the charging operation to the discharging operation at a current limit value exceeding time, measuring a prescribed time period starting from the current limit value exceeding time and compulsorily changing the discharging operation to a next charging operation when the prescribed time period is elapsed, the motor current-carrying time period 601 denoting the charging time period is determined to the value T1 obtained according to the equation (1). Therefore, there is a case where the operation repetition period 603 equal to a sum of both the motor current-carrying time period 601 and the timer operating time period 602 is placed within the audio frequency range. In this case, vibration or noise of the audio frequency range is generated in the motor due to the ripple frequency of the motor current, and noise generated at the start of the driving operation of the motor is increased.

As is described above, because the ripple period multiple phenomenon inevitably occurs in the motor when the driving operation of the motor is started, even though the output current provided for the motor is controlled by the current chopper type PWM motor driving device, a problem has arisen that noise generated at the start of the driving operation of the motor is increased.

Also, even though the current control is performed for the motor according to the motor current control signal by compulsorily changing a charging operation to a discharging operation at a current limit value exceeding time, measuring a prescribed time period starting from the current limit value exceeding time and compulsorily changing the discharging operation to a next charging operation when the prescribed time period is elapsed, the current ripple frequency of the motor current (or output current) is inevitably placed within the audio frequency range. Therefore, a problem has a risen that noise generated at the start of the driving operation of the motor is increased.

### SUMMARY OF THE INVENTION

An object of the present invention is to provide, with due consideration to the drawbacks of the conventional current chopper type PWM motor driving device, a PWM motor driving device in which noise generated in a start operation of a motor is suppressed while preventing a frequency of an output current flowing through the motor from being placed within an audio frequency range at the start of a driving operation of the motor.

The object is achieved by the provision of pulse width modulation motor driving device including PWM duty ratio control signal producing means, rotational frequency detecting means, PWM control means and driving means. In the PWM duty ratio control signal producing means, a PWM duty ratio control signal set to a frequency higher than an audio frequency range and set to a fixed duty ratio is produced. In the PWM control means, a time period ratio of a charging operation to a discharging operation is determined according to the fixed duty ratio of the PWM duty ratio control signal in cases where the rotational frequency of the motor is lower than the prescribed rotational frequency, and a driving control instruction indicating an alternate performance of the charging operation and the discharging operation for the motor with the time period ratio is produced. The driving means drives the motor to alternately perform the charging operation and the discharging operation for the motor with the time period ratio.

In the above configuration, the rotational frequency of the motor is lower than the prescribed rotational frequency at the start of the driving operation of the motor. Because the charging operation and the discharging operation are alternately performed in the motor at the start of the driving operation of the motor with the time period ratio determined according to the fixed duty ratio of the PWM duty ratio control signal, it is prevented that a frequency of an output current flowing through the motor is placed within an audio frequency range due to a ripple period multiple phenomenon. Accordingly, noise generated in the motor can be suppressed at the start of a driving operation of the motor.

Also, the object is achieved by the provision of pulse width modulation motor driving device including current-carrying phase change detecting means for detecting a change of current-carrying phase, and PWM control means for producing a driving control instruction indicating an alternate performance of the charging operation and the discharging operation for the motor with a time period ratio determined according to the fixed duty ratio of the PWM duty ratio control signal in cases where the number of changes of current-carrying phase does not reach a prescribed number. The number of changes of current-carrying phase does not reach a prescribed number at the start of the driving operation of the motor.

Also, the object is achieved by the provision of pulse width modulation motor driving device including PWM control means for producing a driving control instruction indicating an alternate performance of the charging operation and the discharging operation for the motor with a time period ratio determined according to the fixed duty ratio of the PWM duty ratio control signal in cases where an elapsed time from the start of a driving operation of the motor does not reach a prescribed time.

### BRIEF DESCRIPTION OF THE DRAWINGS

FIG. 1 is a block diagram showing the configuration of a PWM motor driving device according to a first embodiment of the present invention;

FIG. 2 is a timing chart of a PWM duty ratio control signal at the start of a driving operation of a motor, a PWM rotation control signal in a steady rotor rotating operation of the motor and an output current flowing through the motor;

FIG. 3 is a block diagram showing a schematic configuration of a conventional current chopper type PWM motor driving device;

FIG. 4 is an explanatory view showing a charging operation and a discharging operation of the conventional current chopper type PWM motor driving device shown in FIG. 3;

FIG. 5 is a timing chart of a PWM carrier signal, an output current in a steady rotor rotating operation and an output current produced due to a ripple period multiple phenomenon at the start of a driving operation; and

FIG. 6 is a timing chart of both a motor current (or driving current) and a motor current control signal of a motor controlled by another conventional PWM motor driving device.

### DETAILED DESCRIPTION OF THE PREFERRED EMBODIMENTS

Embodiments of the present invention will now be described with reference to the accompanying drawings.

Embodiment 1

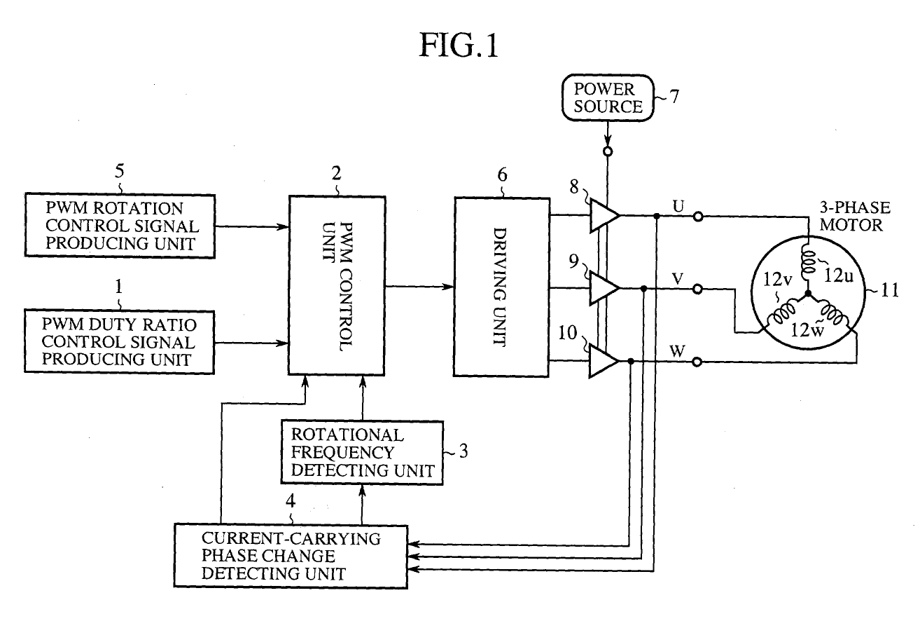

FIG. 1 is a block diagram showing the configuration of a PWM motor driving device according to a first embodiment of the present invention.

In FIG. 1, 12u indicates a U-phase load coil connected to a U-phase terminal U, 12v indicates a V-phase load coil connected to a V-phase terminal V, and 12w indicates a W-phase load coil connected to a W-phase terminal W. 11 indicates a three-phase motor (or motor) driven according to the pulse width modulation (PWM) in response to a driving current flowing through two of the load coils 12u, 12v and 12w. The three-phase motor 11 is driven by repeatedly changing a current path of the driving current to another current path. When the current path of the driving current is changed, this change is called a change of current-carrying phase in this specification.

1 indicates a PWM duty ratio control signal producing unit (PWM duty ratio control signal producing means) for producing a PWM duty ratio control signal in which pulses of a fixed pulse width are set to a frequency higher than 20 kHz denoting a maximum of the audio frequency range and are set to a fixed duty ratio such as 33%. The fixed duty ratio of the PWM duty ratio control signal is set on condition that the driving current does not reach a current limit value when the current path of the driving current is changed in response to each leading edge of the PWM duty ratio control signal at the start of a driving operation of the three-phase motor 11.

5 indicates a PWM rotation control signal producing unit (or PWM signal producing means) for producing a PWM rotation control signal in which pulses of a fixed pulse width are set to a frequency higher than that of the PWM duty ratio control signal and are set to a duty ratio higher than the fixed duty ratio of the PWM duty ratio control signal. Both the duty ratio and the frequency of the PWM rotation control signal are set on condition that a rotor of the three-phase motor 11 is rotated at the highest efficiency when the current path of the driving current is changed in response to each leading edge of the PWM rotation control signal in an steady rotor rotating operation of the three-phase motor 11.

4 indicates a current-carrying phase change detecting unit (or current-carrying phase change detecting means) for detecting a change of current-carrying phase performed in the three-phase motor 11 according to values of currents at the terminals U, V and W of the three-phase motor 11 and producing a pulse of a current-carrying phase change signal each time the change of current-carrying phase is detected. 3 indicates a rotational frequency detecting unit (or rotational frequency detecting means) for detecting a rotational frequency of the three-phase motor 11 according to the pulses of the current-carrying phase change signal sent from the current-carrying phase change detecting unit 4 and producing a rotational frequency signal indicating the rent rotational frequency of the three-phase motor 11.

2 indicates a PWM control unit (PWM control means) for judging according to the rotational frequency signal sent from the rotational frequency detecting unit 3 whether the driving operation of the three-phase motor 11 is just started now or the driving operation of the three-phase motor 11 approaches a steady rotor rotating operation, determining a time period ratio of a charging operation of the three-phase motor 11 to a regenerative operation (or a discharging operation) of the three-phase motor 11 according to the fixed duty ratio of the PWM duty ratio control signal produced by the PWM duty ratio control signal producing unit 1 in cases where it is judged that the driving operation of the three-phase motor 11 is just started now, determining a time period ratio of the charging operation of the three-phase motor 11 to the regenerative operation of the three-phase motor 11 according to the duty ratio of the PWM rotation control signal produced in the PWM rotation control signal producing unit 5 in cases where it is judged that the driving operation of the three-phase motor 11 approaches a steady rotor rotating operation, and producing a driving control instruction indicating an alternate performance of the charging operation and the regenerative operation for the three-phase motor 11 with the time period ratio.

6 indicates a driving unit for driving the three-phase motor 11 according to the driving control instruction produced by the PWM control unit 2 to alternately perform the charging operation and the regenerative operation of the three-phase motor 11 with the determined time period ratio. For example, a change of current-carrying phase in the three-phase motor 11 is performed by the driving unit 6 in response to each leading edge of the pulses of the PWM duty ratio control signal or the PWM rotation control signal, and the driving unit 6 controls the three-phase motor 11 to perform a charging operation in response to each leading edge of the pulses of the PWM duty ratio control signal or the PWM rotation control signal and to perform the regenerative operation in response to each trailing edge of the pulses of the PWM duty ratio control signal or the PWM rotation control signal.

7 indicates a power source for supplying electric power to drive the three-phase motor 11. 8 indicates an output buffer for producing a driving current flowing through the U-phase load coil 12u from the electric power of the power source 7 according to a control signal of the driving unit 6. 9 indicates an output buffer for producing a driving current flowing through the V-phase load coil 12v from the electric power of the power source 7 according to a control signal of the driving unit 6. 10 indicates an output buffer for producing a driving current flowing through the W-phase load coil 12w from the electric power of the power source 7 according to a control signal of the driving unit 6.

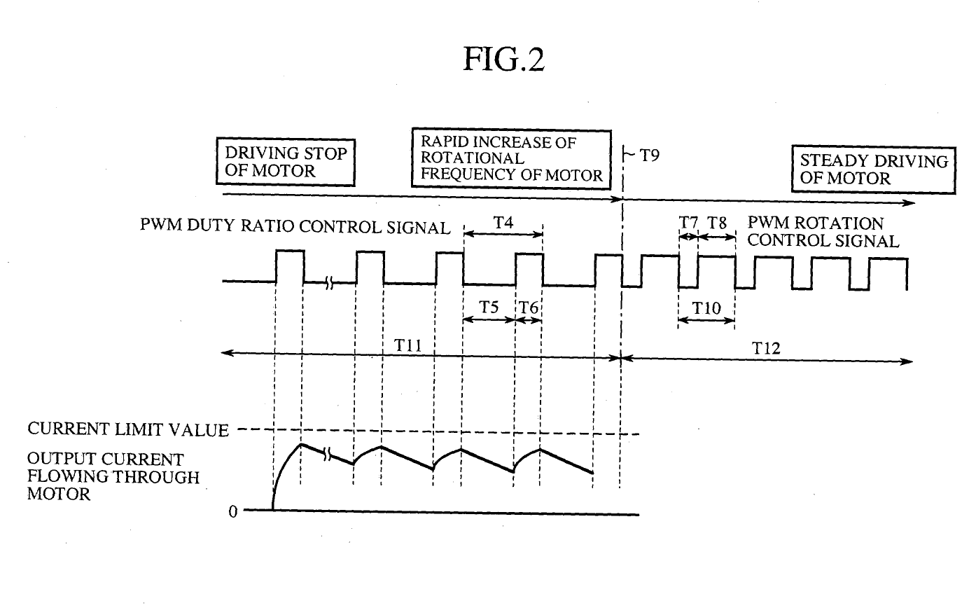

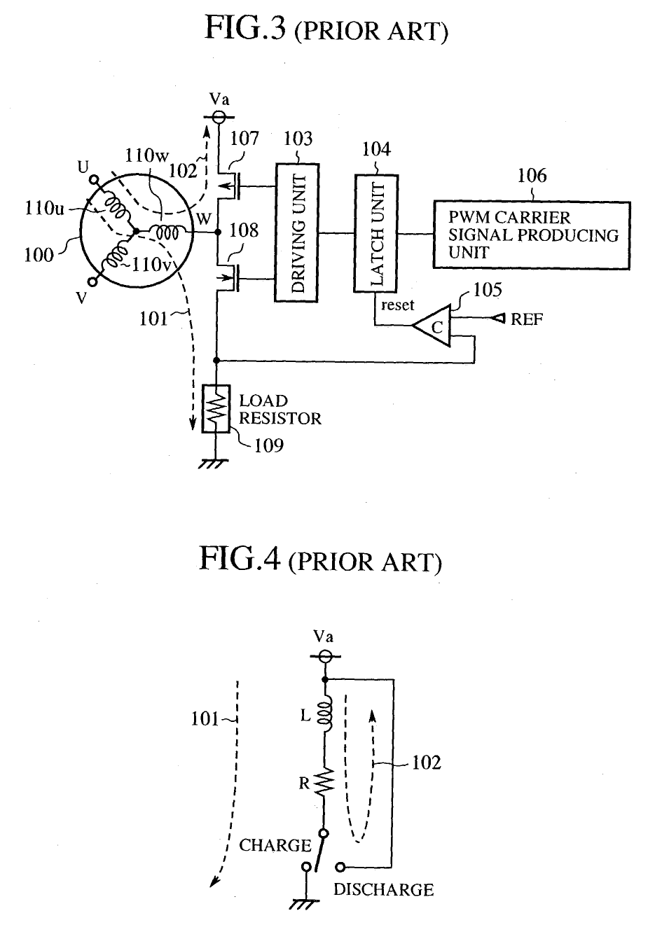

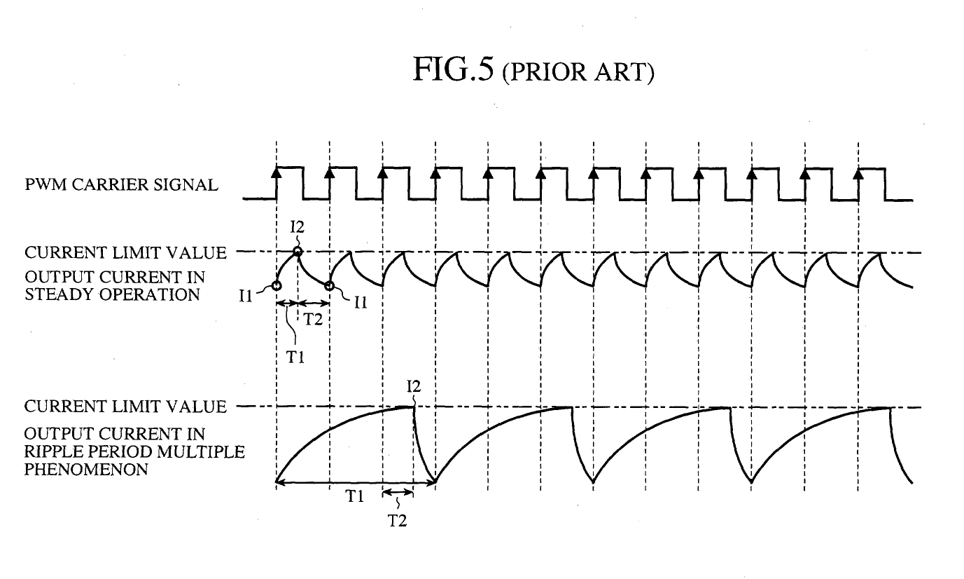

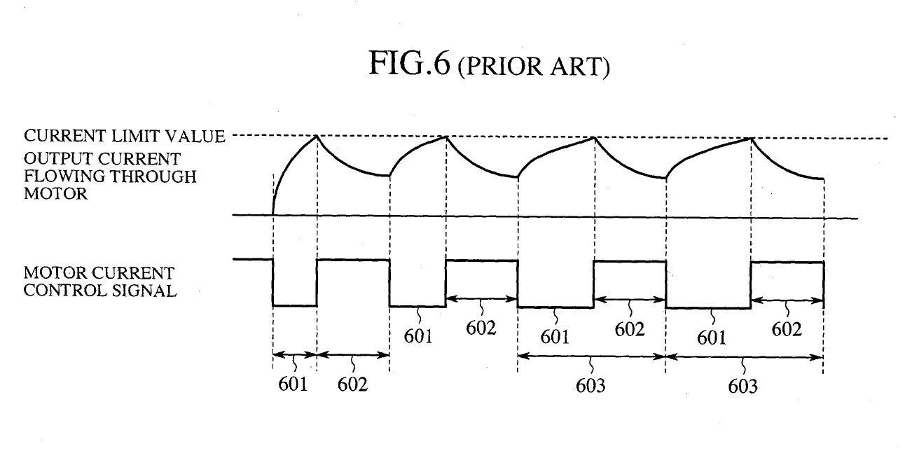

FIG. 2 is a timing chart of the PWM duty ratio control signal at the start of a driving operation of the three-phase motor 11, the PWM rotation control signal in a steady rotor rotating operation of the three-phase motor 11 and an output current flowing through the three-phase motor 11.

Next, an operation of the PWM motor driving device will be described below with reference to FIG. 2.

The PWM duty ratio control signal is produced in the PWM duty ratio control signal producing unit 1. As shown in FIG. 2, the PWM duty ratio control signal has both a pulse having an on-time period T6 corresponding to a charging operation (or a current-carrying operation) and an off-time period T5 corresponding to a regenerative operation (or a discharging operation). A pulse repetition period T4 expressed by a sum of the time periods T5 and T6 is shorter than 50μ second corresponding to a maximum audio frequency of 20 kHz. Therefore, the frequency of the PWM duty ratio control signal is higher than 20 kHz and is placed out of the audio frequency range. Also, the on-time period T6 is equal to 33% of the pulse repetition period T4, and the off-time period T5 is equal to 67% of the pulse repetition period T4. Therefore, the fixed duty ratio of the PWM duty ratio control signal is set to 33%. In cases where the three-phase motor 11 is driven in response to the PWM duty ratio control signal, the charging operation for the load coils 12u, 12v and 12w is performed during the on-time period T6, and the regenerative operation for the load coils 12u, 12v and 12w is performed during the off-time period T5.

Also, the PWM rotation control signal is produced in the PWM rotation control signal producing unit 5. As shown in FIG. 2, the PWM rotation control signal has both a pulse having an on-time period T8 corresponding to the charging operation and an off-time period T7 corresponding to the regenerative operation. A pulse repetition period T10 expressed by a sum of the time periods T7 and T8 is shorter than the pulse repetition period T4 of the PWM duty ratio control signal. Therefore, the frequency of the PWM rotation control signal is higher than that of the PWM duty ratio control signal. Also, a duty ratio of the PWM rotation control signal is higher than the fixed duty ratio of the PWM duty ratio control signal. In cases where the three-phase motor 11 is driven at a rotational frequency higher than a prescribed rotational frequency in response to the PWM rotation control signal to be in a steady rotor rotating operation, the three-phase motor 11 can be driven at the most efficiency.

The PWM duty ratio control signal produced in the PWM duty ratio control signal producing unit 1 and the PWM rotation control signal produced in the PWM rotation control signal producing unit 5 are input to the PWM control unit 2. Also, in the current-carrying phase change detecting unit 4, a change of current-carrying phase is always detected during the driving operation of the three-phase motor 11, and a pulse of a current-carrying phase change signal is produced each time the change of current-carrying phase is detected. In the rotational frequency detecting unit 3, a rotational frequency of the three-phase motor 11 currently driven is detected according to the pulses of the current-carrying phase change signal, and the rotational frequency of the three-phase motor 11 is input to the PWM control unit 2.

In the PWM control unit 2, it is judged according to the rotational frequency signal whether the driving operation of the three-phase motor 11 is just started now or the driving operation of the three-phase motor 11 approaches a steady rotor rotating operation. In cases where the rotational frequency of the three-phase motor 11 indicated by the rotational frequency signal is lower than the prescribed rotational frequency, the PWM control unit 2 judges that the driving operation of the three-phase motor 11 is just started now and the rotational frequency of the three-phase motor 11 is rapidly increased now. In contrast, in cases where the rotational frequency of the three-phase motor 11 indicated by the rotational frequency signal is equal to or higher than the prescribed rotational frequency, the PWM control unit 2 judges that the driving operation of the three-phase motor 11 approaches a steady rotor rotating operation and the rotational frequency of the three-phase motor 11 is gradually increased or steady.

In cases where it is judged that the driving operation of the three-phase motor 11 is just started now, a time period ratio of the charging operation of the three-phase motor 11 to the regenerative operation of the three-phase motor 11 is determined according to the fixed duty ratio of the PWM duty ratio control signal produced by the PWM duty ratio control signal producing unit 1, and a driving control instruction is sent to the driving unit 6. The driving control instruction instructs the driving unit 6 to perform the charging operation of the three-phase motor 11 in response to each leading edge of the pulses of the PWM duty ratio control signal and to perform the regenerative operation of the three-phase motor 11 in response to each trailing edge of the pulses of the PWM duty ratio control signal. That is, the driving control instruction indicates an alternate performance of the charging operation and the regenerative operation for the three-phase motor 11 with the time period ratio determined according to the fixed duty ratio of the PWM duty ratio control signal.

In the driving unit 6, a pair of load coils are cyclically selected from the three load coils 12u, 12v and 12w according to the driving control instruction, and the driving unit 6 drives the three-phase motor 11 to alternately perform the charging operation and the regenerative operation of the three-phase motor 11 with the determined time period ratio. In detail, a pair of load coils (for example, the load coils 12u and 12v) are cyclically selected from the three load coils 12u, 12v and 12w in response to each leading edge of the pulses of the PWM duty ratio control signal. Therefore, a change of current-carrying phase is performed in the three-phase motor 11 under control of the driving unit 6 in response to each leading edge of the pulses of the PWM duty ratio control signal. Also, a charging operation for the selected load coils is compulsorily started under control of the driving unit 6 in response to each leading edge of the pulses of the PWM duty ratio control signal and is continued during the on-time period T6 of each pulse, and a regenerative operation for the selected load coils is compulsorily started under control of the driving unit 6 in response to each trailing edge of the pulses of the PWM duty ratio control signal and is continued during the off-time period T5. This regenerative operation is performed by using a transistor regenerative circuit or a diode regenerative circuit (not shown).

Therefore, the charging and regenerative operations can be reliably performed every pulse repetition period T4 shorter than a cycle 50 μsec corresponding to a maximum audio frequency of 20 kHz.

Also, because the on-time period T6 is set to a short time period while considering the inductance L and resistance R of the selected load coils, the driving current flowing through the load coils cannot reach a current limit value during the on-time period T6. Therefore, a degree of change of an output current (general term of both the driving current and the regenerative current) flowing through the motor 11 is low.

Thereafter, when the driving operation of the three-phase motor 11 is continued during a time period T11, the rotational frequency of the three-phase motor 11 is increased and reaches the prescribed rotational frequency at a time T9. Therefore, the PWM control unit 2 judges that the driving operation of the three-phase motor 11 approaches a steady rotor rotating operation and the rotational frequency of the three-phase motor 11 is gradually increased or steady.

In this case, a time period ratio of the charging operation of the three-phase motor 11 to the regenerative operation of the three-phase motor 11 is determined according to the duty ratio of the PWM rotation control signal produced by the PWM rotation control signal producing unit 5, and a driving control instruction is sent to the driving unit 6. The driving control instruction instructs the driving unit 6 to perform the charging operation of the three-phase motor 11 in response to each leading edge of the pulses of the PWM rotation control signal and to perform the regenerative operation of the three-phase motor 11 in response to each trailing edge of the pulses of the PWM rotation control signal.

In the driving unit 6, a pair of load coils are cyclically selected from the three load coils 12u, 12v and 12w according to the driving control instruction. Therefore, a change of current-carrying phase is performed in the three-phase motor 11 under control of the driving unit 6 in response to each leading edge of the pulses of the PWM rotation control signal. Also, a charging operation for the selected load coils is compulsorily started under control of the driving unit 6 in response to each leading edge of the pulses of the PWM rotation control signal and is continued during the on-time period T8, and a regenerative operation for the selected load coils is compulsorily started under control of the driving unit 6 in response to each trailing edge of the pulses of the PWM rotation control signal and is continued during the off-time period T7.

Here, the duty ratio of the PWM duty ratio control signal is set to a low value of 33% not to increase the driving current to the current limit value. Therefore, assuming that the driving operation of the three-phase motor 11 is continued in response to the pulses of the PWM duty ratio control signal, the rotational frequency of the three-phase motor 11 reaches a limited rotational frequency higher than the prescribed rotational frequency in a long time, the increase of the rotational frequency of the three-phase motor 11 is stopped at the limited rotational frequency, and the rotational frequency of the three-phase motor 11 cannot be increased to a desired rotational frequency (or an ordinarily-used rotational frequency) higher than the limited rotational frequency. In the first embodiment, to reliably increase the rotational frequency of the three-phase motor 11 to the desired rotational frequency in a short time, the PWM control unit 2 monitors the rotational frequency of the three-phase motor 11 detected in the rotational frequency detecting unit 3, a signal used for the control of the driving unit 6 is changed from the PWM duty ratio control signal to the PWM rotation control signal at the time T9 before the rotational frequency of the three-phase motor 11 reaches the limited rotational frequency.

Therefore, the rotational frequency of the three-phase motor 11 can be reliably increased to the desired rotational frequency in a short time.

In the first embodiment, the fixed duty ratio (a ratio of the on-time period T6 to the pulse repetition period T4) of the PWM duty ratio control signal is set to 33%. However, the fixed duty ratio of the PWM duty ratio control signal is appropriately determined while considering the inductance and resistance of the load coils and the ordinarily-used rotational frequency of the three-phase motor 11, and the on-time period T6 of the PWM duty ratio is appropriately set to a low value not to increase the output current flowing through the three-phase motor 11 to the current limit value.

Also, in the first embodiment, an ordinarily-used rotational frequency or a maximum rotational frequency is considerably low in a type of motor. In this case, in the current-carrying phase change detecting unit 4, currents at the terminals U, V and W of the three-phase motor 11 are detected, and the number of changes of current-carrying phase is counted. Thereafter, when the counted number of changes reaches a prescribed number, a signal used for the control of the driving unit 6 is changed from the PWM duty ratio control signal to the PWM rotation control signal in the PWM control unit 2. Also, it is applicable that a signal used for the control of the driving unit 6 be changed from the PWM duty ratio control signal to the PWM rotation control signal after a prescribed elapsed time from the start of the driving operation of the motor while considering characteristics of the motor.

Also, in the first embodiment, the charging operation is started in response to each leading edge of the PWM duty ratio control signal or the PWM rotation control signal, and the regenerative operation is started in response to each trailing edge of the PWM duty ratio control signal or the PWM rotation control signal. However, it is applicable that the charging operation be started in response to each trailing edge of the PWM duty ratio control signal or the PWM rotation control signal, and the regenerative operation be started in response to each leading edge of the PWM duty ratio control signal or the PWM rotation control signal. In short, a time period ratio in the charging operation and the regenerative operation alternately performed is determined according to the duty ratio of the PWM duty ratio control signal or the PWM rotation control signal.

Also, in the first embodiment, it is applicable that the PWM rotation control signal producing unit 5 is included in the PWM control unit 2.

As is described above, in the first embodiment, a pulse frequency of the PWM duty ratio control signal is set to be higher than an audio frequency range, the charging operation for the three-phase motor 11 is compulsorily started in response to each leading edge of the pulses of the PWM duty ratio control signal at the start of the driving operation of the three-phase motor 11, and the regenerative operation for the three-phase motor 11 is compulsorily started in response to each trailing edge of the pulses of the PWM duty ratio control signal at the start of the driving operation of the three-phase motor 11. Therefore, no ripple period multiple phenomenon occurs in the output current (a general term of both the driving current and the regenerative current) flowing through the three-phase motor 11, and the output current flowing through the three-phase motor 11 can be reliably set to a high frequency higher than the audio frequency range. Accordingly, the generation of noise or vibration in the three-phase motor 11 at the start of the driving operation of the three-phase motor 11 can be prevented.

Also, in the first embodiment, the fixed duty ratio of the PWM duty ratio control signal is set to a low value not to increase the driving current to a current upper limit value. Therefore, a difference between a maximum value and a minimum value in the output current flowing through the three-phase motor 11 is reduced to a low value, the rotational frequency of the three-phase motor 11 is smoothly increased, and an adverse influence (the generation of vibration) of the current change on the three-phase motor 11 can be reduced. Accordingly, the generation of vibration in the three-phase motor 11 at the start of the driving operation of the three-phase motor 11 can be further prevented.

Also, in the first embodiment, when the rotational frequency of the three-phase motor 11 reaches a prescribed rotational frequency, it is judged that the driving operation of the three-phase motor 11 approaches a steady rotor rotating operation and the rotational frequency of the three-phase motor 11 is gradually increased or steady, and the driving operation of the three-phase motor 11 is performed in response to the pulses of the PWM rotation control signal having both the duty ratio and the frequency higher than those of the PWM duty ratio control signal. Accordingly, the rotational frequency of the three-phase motor 11 can reliably reach the ordinarily-used rotational frequency in a short time.

Also, in the first embodiment, in cases where an ordinarily-used rotational frequency or a maximum rotational frequency is considerably low in a motor, the number of changes of current-carrying phase is counted in the current-carrying phase change detecting unit 4, and a signal used for the control of the driving unit 6 is changed from the PWM duty ratio control signal to the PWM rotation control signal when the counted number of changes reaches a prescribed number. Therefore, the generation of noise or vibration in the motor at the start of the driving operation of the motor can be prevented.

Also, in the first embodiment, in cases where an ordinarily-used rotational frequency or a maximum rotational frequency is considerably low in a motor, a signal used for the control of the driving unit 6 is changed from the PWM duty ratio control signal to the PWM rotation control signal after a prescribed elapsed time from the start of the driving operation of the motor while considering characteristics of the motor. Therefore, the generation of noise or vibration in the motor at the start of the driving operation of the motor can be prevented.

Also, in the prior art, the current control is performed at the start of the driving operation of the motor in the current chopper type conventional PWM motor driving device while setting a current limit value of the output current flowing though the motor, or the charging and regenerative operations are repeatedly performed while performing each regenerative operation for a fixed time period after the driving current reaches a current limit value. However, as compared with the prior art, in the first embodiment, the charging and regenerative operations for the three-phase motor 11 are compulsorily started at the start of the driving operation of the three-phase motor 11 in response to each leading edge and trailing edge of the pulses of the PWM duty ratio control signal having a pulse frequency higher than an audio frequency range. Accordingly, the generation of noise or vibration in the three-phase motor 11 at the start of the driving operation of the three-phase motor 11 can be prevented.

What is claimed is:

1. A pulse width modulation motor driving device comprising:
PWM duty ratio control signal producing means for producing a PWM duty ratio control signal in which pulses set to a frequency higher than an audio frequency range are set to a fixed duty ratio;
rotational frequency detecting means for detecting a rotational frequency of a motor;
PWM control means for judging according to the rotational frequency detected by the rotational frequency detecting means whether or not the rotational frequency of a motor is lower than a prescribed rotational frequency, determining a time period ratio of a charging operation of the motor to a discharging operation of the motor according to the fixed duty ratio of the PWM duty ratio control signal produced by the PWM duty ratio control signal producing means in cases where it is judged that the rotational frequency of the motor is lower than the prescribed rotational frequency, and producing a driving control instruction indicating an alternate performance of the charging operation and the discharging operation for the motor with the time period ratio; and
driving means for driving the motor according to the driving control instruction produced by the PWM control means to alternately perform the charging operation and the discharging operation of the motor with the time period ratio.

2. The pulse width modulation motor driving device according to claim 1, further comprising:
PWM rotational signal producing means for producing a PWM rotational signal in which pulses set to a frequency higher than that of the PWM duty ratio control signal produced by the PWM duty ratio control signal producing means are set to a duty ratio higher than the fixed duty ratio of the PWM duty ratio control signal, wherein the PWM control means determines a second time period ratio of a charging operation of the motor to a discharging operation of the motor according to the duty ratio of the PWM rotational signal produced by the PWM rotational signal producing means, in cases where it is judged that the rotational frequency of the motor is equal to or higher than the prescribed rotational frequency, to produces a driving control instruction indicating an alternate performance of the charging operation and the discharging operation for the motor with the second time period ratio.

3. The pulse width modulation motor driving device according to claim 1, wherein the fixed duty ratio of the PWM duty ratio control signal is set by the PWM duty ratio control signal producing means not to heighten an output current flowing through the motor to a current limit value in the alternate performance of the charging operation and the discharging operation for the motor with the time period ratio.

4. The pulse width modulation motor driving device according to claim 1, wherein the driving control instruction produced by the PWM control means instructs the driving means to perform the charging operation in response to each leading edge of the pulses of the PWM duty ratio control signal produced by the PWM duty ratio control signal producing means and to perform the discharging operation in response to each trailing edge of the pulses of the PWM duty ratio control signal.

5. The pulse width modulation motor driving device according to claim 2, wherein the PWM control means controls the driving means to drive the motor according to the fixed duty ratio of the PWM duty ratio control signal produced by the PWM duty ratio control signal producing means at the start of a driving operation of the motor and to heighten the rotational frequency of the motor to an ordinarily-used rotational frequency according to the duty ratio of the PWM rotational signal produced by the PWM rotational signal producing means.

6. A pulse width modulation motor driving device comprising:
PWM duty ratio control signal producing means for producing a PWM duty ratio control signal in which pulses set to a frequency higher than an audio frequency range are set to a fixed duty ratio;
current-carrying phase change detecting means for detecting a change of current-carrying phase performed in a motor;
PWM control means for judging whether or not the number of changes of current-carrying phase detected by the current-carrying phase change detecting means reaches a prescribed number, determining a time period ratio of a charging operation of the motor to a discharging operation of the motor according to the fixed duty ratio of the PWM duty ratio control signal produced by the PWM duty ratio control signal producing means in cases where it is judged that the number of changes of current-carrying phase does not reach the prescribed number, and producing a driving control instruction indicating an alternate performance of the charging operation and the discharging operation for the motor with the time period ratio; and
driving means for driving the motor according to the driving control instruction produced by the PWM control means to alternately perform the charging operation and the discharging operation of the motor with the time period ratio.

7. The pulse width modulation motor driving device according to claim 6, further comprising:
PWM rotational signal producing means for producing a PWM rotational signal in which pulses set to a frequency higher than that of the PWM duty ratio control signal produced by the PWM duty ratio control signal producing means are set to a duty ratio higher than the fixed duty ratio of the PWM duty ratio control signal, wherein the PWM control means determines a second time period ratio of a charging operation of the motor to a discharging operation of the motor according to the duty ratio of the PWM rotational signal produced by the PWM rotational signal producing means, in cases where it is judged that the number of changes of current-carrying phase reaches the prescribed number, to produce a driving control instruction indicating an alternate performance of the charging operation and the discharging operation for the motor with the second time period ratio.

8. The pulse width modulation motor driving device according to claim 6, wherein the fixed duty ratio of the PWM duty ratio control signal is set by the PWM duty ratio control signal producing means not to heighten an output current flowing through the motor to a current limit value in the alternate performance of the charging operation and the discharging operation for the motor with the time period ratio.

9. A pulse width modulation motor driving device comprising:
PWM duty ratio control signal producing means for producing a PWM duty ratio control signal in which pulses set to a frequency higher than an audio frequency range are set to a fixed duty ratio;
PWM control means for determining a time period ratio of a charging operation of the motor to a discharging operation of the motor according to the fixed duty ratio of the PWM duty ratio control signal produced by the PWM duty ratio control signal producing means in cases where an elapsed time from the start of a driving operation of the motor does not reach a prescribed time, and producing a driving control instruction indicating an alternate performance of the charging operation and the discharging operation for the motor with the time period ratio; and
driving means for driving the motor according to the driving control instruction produced by the PWM control means to alternately perform the charging operation and the discharging operation of the motor with the time period ratio.

10. The pulse width modulation motor driving device according to claim 9, further comprising:
PWM rotational signal producing means for producing a PWM rotational signal in which pulses set to a frequency higher than that of the PWM duty ratio control signal produced by the PWM duty ratio control signal producing means are set to a duty ratio higher than the fixed duty ratio of the PWM duty ratio control signal, wherein the PWM control means determines a second time period ratio of a charging operation of the motor to a discharging operation of the motor according to the duty ratio of the PWM rotational signal produced by the PWM rotational signal producing means, in cases where the elapsed time from the start of the driving operation of the motor reaches the prescribed time, to produce a driving control instruction indicating an alternate performance of the charging operation and the discharging operation for the motor with the second time period ratio.

11. The pulse width modulation motor driving device according to claim 9, wherein the fixed duty ratio of the PWM duty ratio control signal is set by the PWM duty ratio control signal producing means not to heighten an output current flowing through the motor to a current limit value in the alternate performance of the charging operation and the discharging operation for the motor with the time period ratio.
